(19) United States
(12) Patent Application Publication
(10) Pub. No.: US 2025/0304030 A1
(43) Pub. Date: Oct. 2, 2025

(54) CONTROL DEVICE AND METHOD FOR ESTIMATING DISTANCE TO EMPTY FOR A VEHICLE

(71) Applicant: Scania CV AB, Södertälje (SE)

(72) Inventors: Matthias USSNER, Södertälje (SE); Jukka HYTTINEN, Södertälje (SE); Svante JOHANSSON, Vällingby (SE); Antonius KIES, Södertälje (SE); Tony SANDBERG, Strängnäs (SE)

(73) Assignee: Scania CV AB, Södertälje (SE)

(21) Appl. No.: 18/859,061

(22) PCT Filed: Apr. 25, 2023
(86) PCT No.: PCT/SE2023/050374

§ 371 Date: Oct. 22, 2024

(30) Foreign Application Priority Data
Apr. 29, 2022 (SE) 2250513-5
Apr. 29, 2022 (SE) 2250514-3
Apr. 29, 2022 (SE) 2250515-0

(51) Int. Cl. B60W 20/12; B60W 50/00

(52) U.S. Cl. CPC B60W 20/12; B60W 50/0097; B60W 2050/0028; B60W 2300/125; B60W 2510/244; B60W 2520/10; B60W 2530/10; B60W 2530/16; B60W 2530/20; B60W 2555/20

(57) ABSTRACT

A control device and a method for estimating distance to empty for a vehicle are provided. The method comprises determining an estimated duration of transient temperature behavior of the vehicle for a planned upcoming driving event based on predicted driving conditions of the vehicle for the planned upcoming driving event. The method further comprises determining an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature. The method further comprises estimating the distance to empty based on available driving energy for the vehicle and in consideration of the estimated duration of transient tire rubber temperature and the determined averaged rolling resistance coefficient during the transient tire rubber temperature behavior.

### TECHNICAL FIELD

The present disclosure relates in general to a method for estimating distance to empty for a vehicle. Moreover, the present disclosure relates in general to a control device configured to estimate distance to empty for a vehicle. Furthermore, the present disclosure relates in general to a computer program and a computer-readable medium. The present disclosure also relates in general to a vehicle.

### BACKGROUND

The strive to reduce emissions and improve fuel economy of heavy vehicles, such as trucks and buses, has led to the development of vehicles comprising propulsion systems that uses one or more electrical machines powered by batteries. Examples of such vehicles include Hybrid Electric Vehicles (HEVs), Plug-in Hybrid Electric Vehicles (PHEVs), and Battery Electric Vehicles (BEVs). One of the most important factors to consider for this type of vehicle is the driving range. Every small increment of improved efficiency accounts and is making significant impact to green-house gas emissions. The energy efficiency and desired driving range have a direct impact on the necessary size of the batteries, and thereby also the manufacturing costs as well as operating costs of the vehicle.

The predicted driving range, based on available energy in a vehicle, is commonly referred to as distance to empty (DTE). It is previously known to estimate distance to empty for example by considering historical data regarding average energy consumption rates or efficiency of the vehicle and available energy. However, the accuracy of such an estimation is generally poor since the energy consumption of a vehicle is affected by a large number of factors that may vary largely over time. If the distance to empty cannot be sufficiently accurate determined, it may be necessary to increase the back-up energy stored in the vehicle to account for potential errors in said estimation. This may in turn affect the number and/or duration of charging operations needed, and/or require an increase of the battery size in the vehicle to safely ensure desired driving range. Thus, a more accurate estimation of distance to empty would have potential to provide a considerable reduction of total cost of operation of the vehicle during the service life thereof.

### SUMMARY

The object of the present invention is to improve an estimation of distance to empty for a vehicle.

The object is achieved by the subject-matter of the appended independent claims.

The present disclosure provides a method, performed by a control device, for estimating a distance to empty for a vehicle. The method comprises the steps of:
determining an estimated duration of transient tire rubber temperature behavior of the vehicle for a planned upcoming driving event based on predicted driving conditions of the vehicle for the planned upcoming driving event,
determining an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature, and
estimating the distance to empty based on available driving energy for the vehicle and in consideration of the estimated duration of transient tire rubber temperature behavior and the determined averaged rolling resistance coefficient during the transient tire rubber temperature behavior.

By means of the present method, the estimation of a vehicle's distance to empty is significantly improved since it takes into account the variation in rolling resistance that may occur during a driving event. This means that a higher trust in the estimation of distance to empty may be achieved from a user of the vehicle. This also means that less back-up driving energy need to be stored onboard the vehicle. This in turn improves the total cost of operation of the vehicle.

The step of determining estimated duration of transient tire rubber temperature behavior may comprise estimating an initial tire rubber temperature at the start of the planned upcoming driving event, and, based on the estimated initial tire rubber temperature, ambient temperature and the predicted driving conditions for the vehicle, determining an estimated duration until the tire has reached a temperature equal to or above a predetermined temperature threshold. Thereby, the determination of estimated duration of transient tire rubber temperature may be more accurate which in turn increases the accuracy in the estimated distance to empty.

The method may further comprise identifying one or more portions of the planned driving event during which a transient tire rubber temperature behavior of the vehicle may occur. In such a case, the steps of determining an estimated duration of transient tire rubber temperature behavior of the vehicle for the planned upcoming driving event based on predicted driving conditions of the vehicle for the planned upcoming driving event and determining an average rolling resistance coefficient during the transient tire rubber temperature behavior may be performed for each of said one or more identified portions of the planned driving event. The step of estimating distance to empty may then be performed in consideration of the estimated duration of transient tire rubber temperature and the determined averaged rolling resistance coefficient during the transient tire rubber temperature behavior for each of said one or more identified portions of the planned driving event.

The step of determining an estimated duration of transient tire rubber temperature behavior may comprise determining the estimated duration of transient tire rubber temperature based on stored reference data, such as a look-up table. Thereby, the method for estimating distance to empty may be facilitated.

The predicted driving conditions may suitably comprise at least vehicle speed and vehicle load.

The predetermined transient rolling resistance coefficient model may further take into account an estimated tire rubber temperature at the initiation of the transient tire rubber temperature behavior. Thereby, the accuracy in the estimated distance to empty is further improved.

The predetermined transient rolling resistance coefficient model may further take into account one or more parameters that may cause a cooling or warming effect of the tire during driving. Thereby, the accuracy in the estimated distance to empty is further improved.

The one or more parameters that may cause a cooling or warming effect of the tire during driving may comprise rain, wet road conditions, humidity and/or braking.

The present disclosure further relates to a computer program comprising instructions which, when executed by a control device, cause the control device to carry out the method as described above.

The present disclosure further relates to a computer-readable medium comprising instructions which, when executed by a control device, cause the control device to carry out the method as described above.

Moreover, in accordance with the present disclosure, a control device configured to estimate distance to empty for a vehicle is provided. The control device is configured to:
determine an estimated duration of transient tire rubber temperature behavior of the vehicle for a planned upcoming driving event based on predicted driving conditions of the vehicle for the planned upcoming driving event,
determine an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature, and
estimate the distance to empty based on available driving energy for the vehicle and in consideration of the estimated duration of transient tire rubber temperature behavior and the determined averaged rolling resistance coefficient during the transient tire rubber temperature behavior.

The control device provides the same advantages as described above with reference to the corresponding method for estimating distance to empty for a vehicle.

The present disclosure further provides a vehicle comprising the control device described above. The vehicle may be a heavy land-based vehicle, such as a truck or a bus. The vehicle may be a battery electric vehicle, a hybrid vehicle, a plug-in hybrid vehicle, or a fuel cell vehicle, but is not limited thereto.

### BRIEF DESCRIPTION OF DRAWINGS

FIG. 1 schematically illustrates a side view of an example of a vehicle,

FIG. 2 represents a flowchart schematically illustrating one exemplifying embodiment of the herein described method for estimating distance to empty for a vehicle,

FIG. 3 schematically illustrates a device that may constitute, comprise or be a part of the control device configured to estimate distance to empty according to the present disclosure,

FIG. 4 illustrates rolling resistance measurements plotted over time at different ambient temperatures as derived through experimental tests,

FIG. 5 shows the rolling resistance measurements normalized with the measured stabilized Cᵣᵣ value at +25° C.,

FIG. 6 illustrates stabilized difference between ambient temperature and tire rubber temperature over different ambient temperatures,

FIG. 7 illustrates stabilized rolling resistance plotted over different ambient temperatures,

FIG. 8 illustrates the rolling resistance plotted over tire rubber temperature at the tire shoulder at various ambient temperatures,

FIG. 9 illustrates rolling resistance plotted over tire rubber temperature at the apex of the tire,

FIG. 10 illustrates the temperature warm up at (a) the tire apex and (b) the tire shoulder,

FIG. 11 illustrates difference between tire shoulder temperature and ambient temperature plotted over time,

FIG. 12 illustrates rolling resistance results with dry and wet driving conditions plotted over time,

FIG. 13 illustrates actual rolling resistance and averaged rolling resistance for a given drive time at different ambient temperatures,

FIG. 14 illustrates simulated BET driving range when rolling resistance and air density is varied with 0% and 100% relative air humidity,

FIG. 15 illustrates range calculations with varying drive time at different ambient temperatures,

FIG. 16 schematically illustrates changes on rolling resistance over time when the vehicle speed is changed, and

FIG. 17 schematically illustrates a cross-sectional view of a tire.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

The present disclosure relates to a method for estimating a vehicle's distance to empty (DTE). The term “distance to empty” as used herein is intended to mean the range the vehicle may be driven based on the vehicle's available driving energy. Said driving energy may for example be stored in an energy storage device, such as an energy storage device comprising one or more batteries, and/or be in form of liquid or gaseous fuel (such as in the case of biogas driven vehicles or fuel cell vehicles) onboard the vehicle.

In the present disclosure, the feature “transient tire temperature behavior” is considered to mean an event (during driving of the vehicle) where the tire temperature (i.e. the temperature of the rubber in the tire) varies over time, and where said variation is greater than a preselected temperature difference threshold. Said preselected temperature difference threshold may for example be set to 3° C., 5° C. or 8° C., but is not limited thereto.

The herein described method is primarily developed for use in conjunction with vehicles comprising a propulsion unit that may be powered by an energy storage device, such as a hybrid vehicle, a fully electric vehicle or a fuel cell vehicle. It should however be noted that the herein described method may also be utilized for other vehicles, such as conventional vehicles driven (solely) by a combustion engine. The vehicle is however a land-based vehicle comprising at least one tire. Furthermore, the herein described method is primarily developed for a heavy vehicle, such as a truck or a bus. The method may however be used also for other vehicles, such as passenger cars or a vehicle belonging to the lightweight or mediumweight segment of trucks, if desired.

In general, distance to empty may be estimated by considering the propulsion power needed for driving the vehicle as planned or desired and the available driving energy (i.e. available propulsion energy). The propulsion power is in turn dependent on the force opposing the vehicle's motion, the vehicle's efficiency (more specifically, powertrain efficiency), and the vehicle speed. The force opposing the vehicle's motion comprises the sum of a force caused by rolling resistance, a force caused by air resistance and a force caused by slope of the road. Also, the distance to empty is affected by other energy consumers of the vehicle, for example systems for climatizing the interior of the vehicle or systems for controlling operating temperature of the energy storage device. Thus, it is evident that the instantaneous propulsion power needed will vary over time during a driving event, for example due to possible variation in vehicle speed and characteristics of the road section.

One of the largest parts of the power losses for heavy vehicles is caused by tire rolling resistance, as mentioned above. Today, tire manufacturers are required to test rolling resistance in accordance with standardized tests in order to obtain certain labels. For example, in Europe, to obtain the UNECE R117 label (Amendment of Rolling Resistance in R117, 2009) the tire manufacturers are mandated to test rolling resistance according to the ISO 28580:2009 test standard. This test method merely provides a value of stabilized rolling resistance at +25° C. ambient temperature after 3 h. This is a convenient method to compare rolling resistance of different tires. However, in real road applications, rolling resistance is much more complex. This in turn results in difficulties if the rolling resistance provided according to this standard is used in simulations of driving energy consumption for a vehicle. More specifically, one of the drawbacks of the ISO 28580:2009 test standard is that it does not take into account variations of ambient temperature or transient rolling resistance. Other test standards exist, such as SAE J1269 and SAE J2452. SAE J2452 considers also vehicle speed, which is advantageous. However, SAE J1269 and SAE J2452 also have the drawback of not considering the effects of transient rolling resistance and different ambient temperatures.

The European Commission has developed a vehicle energy consumption calculation tool called VETCO, with the purpose of determining CO₂ emissions and fuel consumption from heavy duty Vehicles with a Gross Vehicle Weight above 3500 kg. The inputs for VECTO are characteristic parameters to determine the power consumption of every relevant vehicle component. Amongst others, the parameters for rolling resistance, air drag, masses and inertias, gearbox friction, auxiliary power and engine performance are input values to simulate fuel consumption and CO₂ emissions on standardized driving cycles. However, the tool uses constant rolling resistance values and disregards the effect of ambient temperature on rolling resistance and transient rolling resistance.

To improve the prediction of driving energy consumption in real operational conditions and estimations using various simulation tools, it would be beneficial to obtain more data regarding rolling resistance at various ambient temperatures and different operating conditions of the vehicle. Most of the rolling resistance is related to the viscoelastic behavior of tire rubber when strain is imposed while rolling. In a rolling motion, the rubber compresses at the leading edge of the tire contact patch and decompresses at the trailing edge of the contact patch. These subsequent loading and unloading events form an asymmetric contact pressure that shifts the resultant force in front of the tire rotation axis with an offset. This shifted resultant force creates a braking moment, which is the largest part of the rolling resistance. Moreover, viscoelasticity dissipates energy into heat that in turn cause warming of the tire.

The loading and unloading of the rubber causes hysteresis resulting from reorganization of entanglements of polymer chains and breaking of vas der Waals bonds, which are affected by temperature. Thus, rolling resistance increases with decreasing temperature of the tire rubber.

During driving of a vehicle, the tire warms up until the strain-induced heating effect and cooling effects from the surrounding environment (and road) reach a thermal balance. During this warm-up period rolling resistance is decreased considerably, and results in transient rolling resistance. Transient rolling resistance can also occur as a result of for example change in vehicle speed and/or sudden change in weather condition.

The research performed until now has not resulted in a complete understanding of rolling resistance under realistic driving conditions, except in situations where steady-state conditions are present. However, the present inventors have performed extensive testing, part of which will be described below, to investigate the effect of tire rubber temperature on rolling resistance. It has been found that transient rolling resistance resulting from temperature changes in the tire rubber, more specifically temperature changes in the circumferential portion of the tire, has a great impact on distance to empty for a vehicle. Furthermore, it has been found that the ambient temperature also greatly affects the steady-state rolling resistance as well as the transient rolling resistance. Measuring the tire rubber temperature at the circumferential portion of the tire during actual driving is in practice not possible due to the difficulty in arranging a temperature sensor at a relevant position in the tire. However, the present inventors have found that it is possible to model the transient rolling resistance and that it is therefore possible to take this into account when estimating distance to empty. This greatly improves the accuracy in the estimated distance to empty.

It should be noted that this is not the same thing as measuring the tire pressure or the temperature of the air/fluid inside the tire, which are more of secondary effects, since they follow on/after the change in rubber temperature caused by rubber stress/strain—hysteresis, as described above. Therefore, when wanting to accurately estimate rolling resistance, it is important to look at the first order effect (rubber temperature), and not on less accurate results caused by the first order effect. Thus, although the tire pressure also may change due to temperature variations of the air/fluid inside the tires, these changes do not reflect the actual behaviour of the rolling resistance. As mentioned above, this tire pressure (and corresponding fluid temperature) is a secondary result and will also, in addition to not accurately representing the rubber temperature/rolling resistance, have a time delay to the actual rubber temperature/rolling resistance.

In accordance with the present disclosure, a method for estimating distance to empty for a vehicle is provided. The method comprises a step of determining an estimated duration of transient tire rubber temperature behavior of the vehicle for a planned upcoming driving event based on predicted driving conditions of the vehicle for the planned upcoming driving event. The transient tire rubber temperature behavior may preferably be a transient tire rubber temperature at the circumferential portion of the tire. The method further comprises a step of determining an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature. The method further comprises a step of estimating the distance to empty based on available driving energy for the vehicle and in consideration of the estimated duration of transient tire rubber temperature behavior and the determined averaged rolling resistance coefficient during the transient tire rubber temperature behavior.

The above mentioned planned upcoming driving event may be an event where the vehicle is driven through the entire event, for example during long haulage, or comprise one or more temporary stops of the vehicle, such as in the case of a distribution truck or a city bus.

Furthermore, predicted driving conditions of the vehicle during the driving event may for example comprise vehicle speed, vehicle load, propulsion unit used (in the case of more than one propulsion unit available), and acceleration/deceleration etc. The predicted driving conditions of the vehicle may typically vary over time during the planned driving event.

One example of a situation where transient tire rubber temperature behavior will occur is at the start of a driving event after the vehicle has been at standstill for a period of time, since the tire will warm up during the initial portion of the driving event due to the strain induced in the tire caused by loading/unloading of the rubber. If the vehicle is thereafter driven at a substantially constant driving speed and there is no alteration of the surrounding environment, the tire will eventually reach a substantially steady-state temperature and thereby reach a substantially stead-state rolling resistance coefficient. This may for example be the case for long haulage vehicles. In case the vehicle is for example a distribution truck, each temporary stop may in turn lead to a cooling of the tires during the stop and also that a substantially steady-state tire rubber temperature is not reached between the stops.

Therefore, the step of determining estimated duration of transient tire rubber temperature behavior may comprise estimating an initial tire rubber temperature at the start of the planned upcoming driving event, and determining, based on the estimated initial tire rubber temperature, the ambient temperature and the predicted driving conditions for the vehicle, whether the tire rubber temperature will reach a temperature equal to or above a predetermined temperature threshold. Said predetermined temperature threshold may correspond to a temperature at which the tire is considered to have reached a substantially steady-state temperature based on a thermal balance between a strain-induced heating effect of the tire and cooling effects from the surrounding environment. It should here be noted that said predetermined temperature threshold is dependent of ambient temperature. In case the tire rubber temperature will not reach a temperature equal to or above the predetermined temperature threshold during the driving event, the transient tire rubber temperature behavior will not end during the driving event. However, if it is determined that the tire rubber temperature will reach a temperature equal to or above the predetermined temperature threshold, the duration of transient tire rubber temperature behavior may be considered to be terminated at the point in time at which said temperature will be reached.

In other words, the step of determining estimated duration of transient tire rubber temperature behavior may comprise estimating an initial tire rubber temperature at the start of the planned upcoming driving event, and based on the estimated initial tire rubber temperature, ambient temperature and the predicted driving conditions for the vehicle, determining an estimated duration until the tire has reached a temperature equal to or above a predetermined temperature threshold.

Estimating an initial tire rubber temperature at the start of transient tire rubber temperature behavior may be made based on the conditions to which the tire has been subjected before the start of transient tire rubber temperature behavior. For example, if the vehicle has been at standstill for an extended period of time, the tire rubber temperature may be estimated to correspond to the ambient temperature. However, if the vehicle has had only a short driving stop, the tire rubber temperature may not have reached the ambient temperature and the initial temperature may therefore be estimated based on previous driving conditions and the possible cooling of the tire rubber temperature that may have occurred during the short stop. In case the transient tire rubber temperature behavior is initiated by for example a change in speed during driving, the initial tire rubber temperature at the start of the transient tire rubber temperature may be estimated based on driving conditions of the vehicle shortly before the initiation of the transient tire rubber temperature behavior.

Moreover, the method may further comprise identifying one or more portions of the planned driving event during which a transient tire rubber temperature behavior of the vehicle may occur. Said portions may for example be separated from each other by planned stops of the vehicle during the driving event, a planned change in vehicle speed (for example from 50 km/h to 80 km/h) or the like. In the method comprises identifying one or more portions of the planned driving event during which a transient tire rubber temperature behavior of the vehicle may occur, the steps of determining an estimated duration of transient tire rubber temperature behavior of the vehicle for the planned upcoming driving event based on predicted driving conditions of the vehicle for the planned upcoming driving event and of determining an average rolling resistance coefficient during the transient tire rubber temperature behavior may be performed for each of said one or more identified portions of the planned driving event. The step of estimating distance to empty may then be performed in consideration of the estimated duration of transient tire rubber temperature and the determined averaged rolling resistance coefficient during the transient tire rubber temperature behavior for each of said one or more identified portions of the planned driving event.

The step of determining an estimated duration of transient tire rubber temperature behavior comprises determining the estimated duration of transient tire rubber temperature based on stored reference data, such as a look-up table. Such reference data may be determined through experimental tests, for example test as will be described below. Here, it should be noted that such reference data have not previously been available as, for example, transient tire rubber temperature during realistic driving conditions has not been investigated. However, such reference data may be determined by repeating the tests described below at various conditions, such as different vehicle speeds and ambient temperatures.

The predetermined transient rolling resistance coefficient model may, in addition to ambient temperature further take into account an estimated tire rubber temperature at the initiation of the transient tire rubber temperature behavior. Alternatively or additionally, the predetermined transient rolling resistance coefficient model may further take into account one or more parameters that may cause a cooling or warming effect of the tire during driving. Examples of such parameters include rain, wet road conditions, humidity and/or braking.

The performance of the herein described method for estimating distance to empty for a vehicle may be governed by programmed instructions. These programmed instructions typically take the form of a computer program which, when executed in or by a control device, cause the control device to effect desired forms of control action. Such instructions may typically be stored on a computer-readable medium.

The present disclosure further relates to a control device configured to estimate distance to empty for a vehicle in accordance with the method described above. The control device may be configured to perform any one of the steps of the method for estimating distance to empty for a vehicle as described herein.

More specifically, in accordance with the present disclosure a control device configured to estimate distance to empty for a vehicle is provided. The control device is configured to determine an estimated duration of transient tire rubber temperature behavior of the vehicle for a planned upcoming driving event based on predicted driving conditions of the vehicle for the planned upcoming driving event. The control device is further configured to determine an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature. Moreover, the control device is configured to estimate the distance to empty based on available driving energy for the vehicle and in consideration of the estimated duration of transient tire rubber temperature and the determined averaged rolling resistance coefficient during the transient tire rubber temperature behavior.

The control device may further be configured to determine available driving energy for the vehicle, or communicate with another control system, for example a battery management system, for the purpose of obtaining information regarding available driving energy for the vehicle.

Moreover, the control device may be configured to communicate with one or more other controllers and/or sensors of the vehicle or associated therewith for the purpose of obtaining data for the purpose of performing the herein described method. Alternatively, or additionally, the control device may be configured to determine data to be used for the purpose of performing the herein described method.

The control device may comprise one or more control units. In case of the control device comprising a plurality of control units, each control unit may be configured to control a certain function or a certain function may be divided between more than one control units.

The control device may be a control device arranged onboard the vehicle, or a control device arranged remote from the vehicle. If arranged remote from the vehicle, the control device may be configured to communicate with one or more vehicle controllers arranged onboard the vehicle, for example in order to present information to a driver of the vehicle or to control the vehicle. Alternatively, parts of the control device may, if desired, be arranged remote from the vehicle. For example, one or more control units of the control device may be arranged at a remote control center and configured to communicate with one or more control units of the control device arranged on board the vehicle.

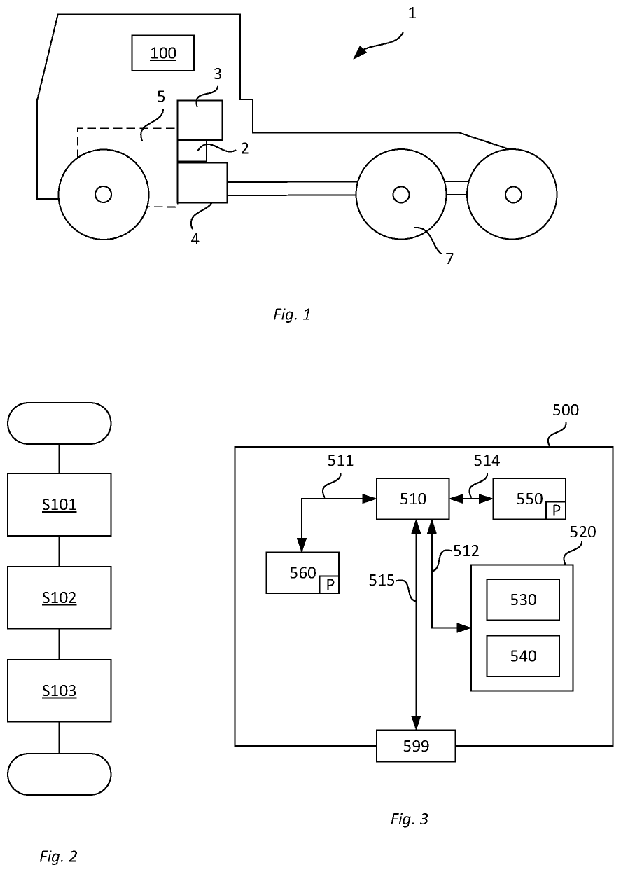

FIG. 1 schematically illustrates a side view of an example of a vehicle 1. The vehicle may be a fully electric vehicle or a hybrid vehicle. Furthermore, the vehicle may be a heavy vehicle, such as a bus or a truck, but is not limited thereto. The vehicle 1 comprises a first propulsion unit in the form of an electric motor 2. The electric motor 2 is powered by an energy storage device 3 of the vehicle. The vehicle 1 may comprise a second propulsion unit, such as a combustion engine 5 and/or a second electric motor (not shown), if desired. The electric motor 2 may further be operated as a generator, for example during regenerative braking of the vehicle, and thereby charging the energy storage device. The vehicle 1 may further comprise a gearbox 4 configured to selectively transfer propulsion torque from the propulsion unit(s) to the driving wheels 7 of the vehicle.

The vehicle 1 may further comprise a control device 100 configured to estimate distance to empty. The control device 100 may be configured to communicate with a remote control center, control devices of other vehicles, and/or control units of the infrastructure, via any previously known communication system therefore, for the purpose of exchanging various forms of data. Examples of such data may comprise data for positioning of the vehicle and/or map data (including topographic data), data regarding speed limits or other traffic data (such as potential queuing or the like), and/or meteorological data.

FIG. 2 represents a flowchart schematically illustrating one exemplifying embodiment of the method for estimating distance to empty in accordance with the present disclosure. The method comprises a step S101 of determining an estimated duration of transient tire rubber temperature behavior of the vehicle for a planned upcoming driving event based on predicted driving conditions of the vehicle for the planned upcoming driving event. The method further comprises a step S102 of determining an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature. The method further comprises a step S103 of estimating the distance to empty based on available driving energy for the vehicle and in consideration of the estimated duration of transient tire rubber temperature and the determined averaged rolling resistance coefficient during the transient tire rubber temperature behavior.

FIG. 3 schematically illustrates an exemplifying embodiment of a device 500. The control device 100 described above may for example comprise the device 500, consist of the device 500, or be comprised in the device 500.

The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

There is provided a computer program P that comprises instructions for estimating distance to empty for a vehicle. The computer program comprises instructions for determining an estimated duration of transient tire rubber temperature behavior of the vehicle for a planned upcoming driving event based on predicted driving conditions of the vehicle for the planned upcoming driving event. The computer program further comprises instructions for determining an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature. The computer program further comprises instructions for estimating the distance to empty based on available driving energy for the vehicle and in consideration of the estimated duration of transient tire rubber temperature behavior and the determined averaged rolling resistance coefficient during the transient tire rubber temperature behavior.

The program P may be stored in an executable form or in a compressed form in a memory 560 and/or in a read/write memory 550.

The data processing unit 510 may perform one or more functions, i.e. the data processing unit 510 may effect a certain part of the program P stored in the memory 560 or a certain part of the program P stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit 510 via a data bus 511. The read/write memory 550 is adapted to communicate with the data processing unit 510 via a data bus 514. The communication between the constituent components may be implemented by a communication link. A communication link may be a physical connection such as an optoelectronic communication line, or a non-physical connection such as a wireless connection, e.g. a radio link or microwave link.

When data are received on the data port 599, they may be stored temporarily in the second memory element 540. When input data received have been temporarily stored, the data processing unit 510 is prepared to effect code execution as described above.

Parts of the methods herein described may be affected by the device 500 by means of the data processing unit 510 which runs the program stored in the memory 560 or the read/write memory 550. When the device 500 runs the program, methods herein described are executed.

In the following, rolling resistance tests will be described for the purpose of demonstrating the temperature effect on rolling resistance for a heavy vehicle, here in the form of a truck. The rolling resistance tests were conducted at Scania's climate wind tunnel where the ambient temperature can be altered. The measurement drum has a diameter of 2.5 m, which is 0.5 m larger than the recommended diameter in the ISO 28580:2009 standard. The usage of the larger drum than according to the standard has the advantage of causing less warming up of the tires and better mimics a flat road. If the drum diameter is too small, the tire rubber temperature becomes too high, and the measurement results might become less relevant. Approximation equations to convert drum measurements to flat road results are commonly known. However, in the present disclosure, the measurements given are direct drum tests where no conversion equations were used.

The wind and drum speed were set to 80 km/h and the tests were conducted at four different ambient temperatures, namely +25° C., +5° C., −15° C., and −30° C. To make it relevant to measure the tire in such a large temperature range, the chosen tire has a Mud+Snow (M+S) and Three Peak Mountain Snow Flake (3PMSF) marking for winter usage. Dual tires were used on the measured axle. The measured tires had a 5.1 kg/ton labelled rolling resistance value (class C rolling resistance (EU, 2009)).

Before the tests, the tires were preconditioned by driving them 1500 km using 10 500 kg axle load and 8.5 bar inflation pressure. The reason for said preconditioning was that the measurements would show the actual rolling resistance instead of evaluating the reduction of rolling resistance because of strain-softening in new tires. To measure the tire rubber temperature, the tires were equipped with K-type thermocouples. These K-type thermocouples were glued into drilled holes located at the tire shoulder and near the apex, respectively. In order to ensure that the tires had a substantially homogenous and known temperature at the start of the tests, the tires were kept in the measurement temperature (i.e. the different ambient temperatures) for at least 12 hours before starting the tests.

To separate tire rolling resistance from the gearbox and differential losses, the drive shafts were removed during the tests. Moreover, before the start of every test, the truck was lifted with an overhead crane and the drum was driven for 30 minutes (at 80 km/h) to warm up the drum bearings and stabilize the force measurement. The last averaged value of the drum rolling loss was subtracted afterwards from the rolling resistance measurements to remove most of the parasitic losses from the drum bearings. After this, the drive axle was lowered on the drum so that the tires were barely touching the drum and driven for 15 minutes. This step was done to warm up the wheel bearings. Finally, the tire pressure was adjusted to 8.5 bar, the axle was lowered on the drums and 10.2 tons axle load was applied on the drive axle. These steps were repeated in all of the measurement temperatures. This means that the measured rolling resistance includes the losses from the wheel bearings and the aerodynamic resistance of the tires. The effects of these are however estimated to be considerably lower than the rolling resistance caused by the viscoelastic effects.

The change of rolling resistance in wet driving conditions was measured by spraying water on the tires. During the rain/wet tests, 0.2 I/s water was sprayed to the left tires at 80 km/h vehicle speed. Here, the hydrodynamic effects (i.e. pumping of a water layer away from the contact patch) are considered to be close to zero because of the relatively low amount of water spraying and the usage of the outer drum measurements where the water layer build-up is less likely than if using flat surface measurements.

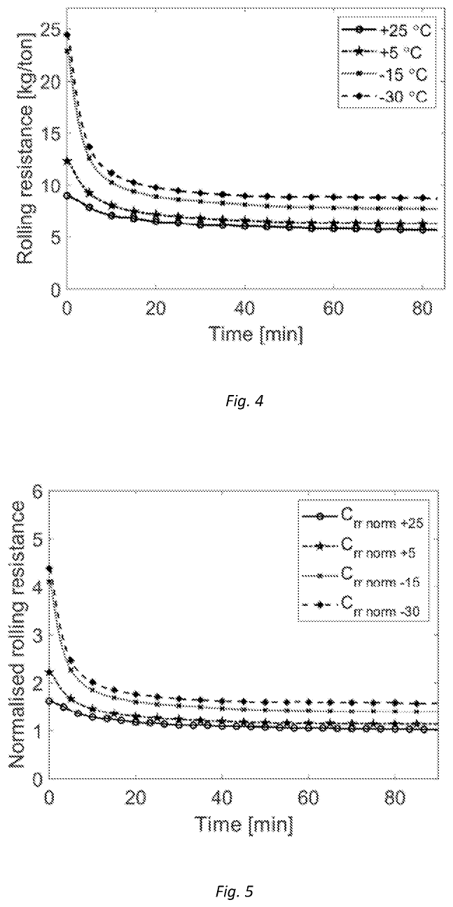

FIG. 4 illustrates rolling resistance plotted over time at different ambient temperatures according to the dry test. From the results, it can be seen that the transient rolling resistance starts with a higher value and reaches a lower, stabilized, rolling resistance roughly after 45-80 minutes. Furthermore, it is shown that, with decreasing ambient temperature, the rolling resistance increases. The (measured) rolling resistance is hereafter also denominated Cᵣᵣ.

FIG. 5 shows the rolling resistance measurements normalized with the measured stabilized Cᵣᵣ value at +25° C. It has been found that, at −15° C. and −30° C., the initial rolling resistance is over four times the stabilized rolling resistance at +25° C. At −30° C., the stabilized rolling resistance is approximately 1.65 larger compared to the values at +25° C.

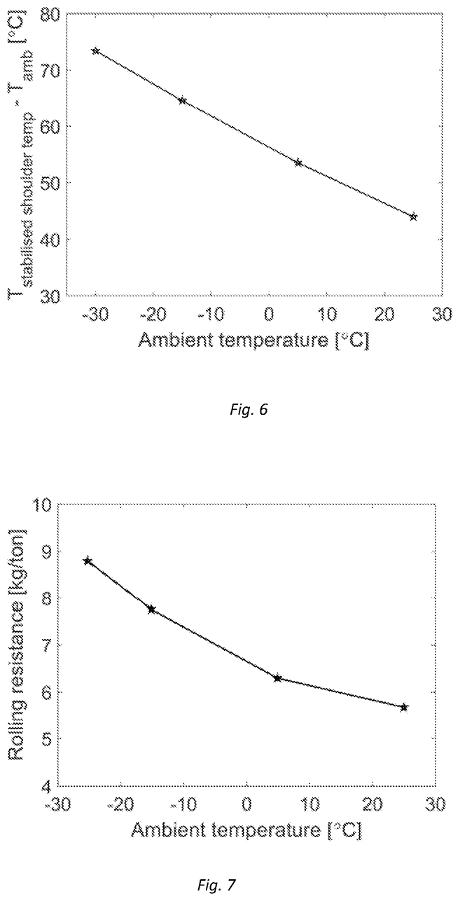

The temperature difference between the stabilized tire shoulder temperature (T_{stabilised shoulder temp}) and ambient temperature (T_{amb}) has a linear relationship with ambient temperature, as shown in FIG. 6, while the stabilized rolling resistance as a function of ambient temperature has a nonlinear relationship, as shown in FIG. 7. An increase in tire rubber temperature during driving directly indicates that the tires dissipate a larger amount of energy.

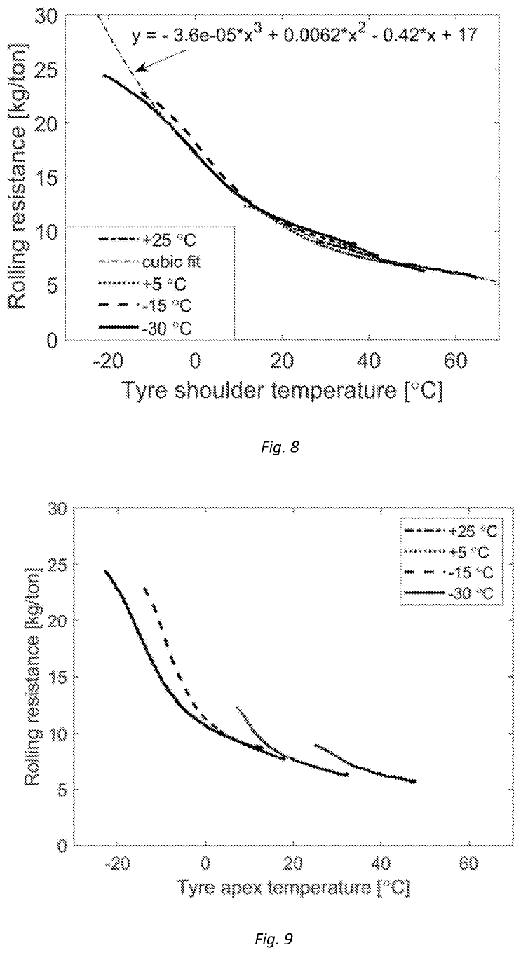

FIG. 8 illustrates the rolling resistance plotted over tire rubber temperature at the tire shoulder at various ambient temperatures, and FIG. 9 illustrates the rolling resistance plotted over tire rubber temperature at the apex. These figures demonstrate that rolling resistance seems to have a strong correlation with the tire shoulder temperature. However, temperature measurements near the apex seem to be a less relevant indicator for the rolling resistance.

Based on the results, it has been found that it is possible to approximate the rolling resistance Cᵣᵣ as a function of tire rubber temperature T_{tire-cir} at a circumferential portion of the tire (such as the tire shoulder temperature according to the measurements) using a cubic function according to Equation 1.

$${C}_{r r} = {k}_{1} * {T}_{t i r e - c i r}^{3} + {k}_{2} * {T}_{t i r e - c i r}^{2} + {k}_{3} * {T}_{t i r e - c i r} + {k}_{4} \qquad Eq . l$$

where k₁, k₂, k₃ and k₄ each represents coefficients. Although the coefficients would vary, Equation 1 is believed to be applicable to all pneumatic tires, or at least pneumatic tires with filler reinforced rubber. For the specific results shown in FIG. 8, k₁=−3.6e −05, k₂=0.0062, k₃=0.42, and k₄=17 as also illustrated in the figure.

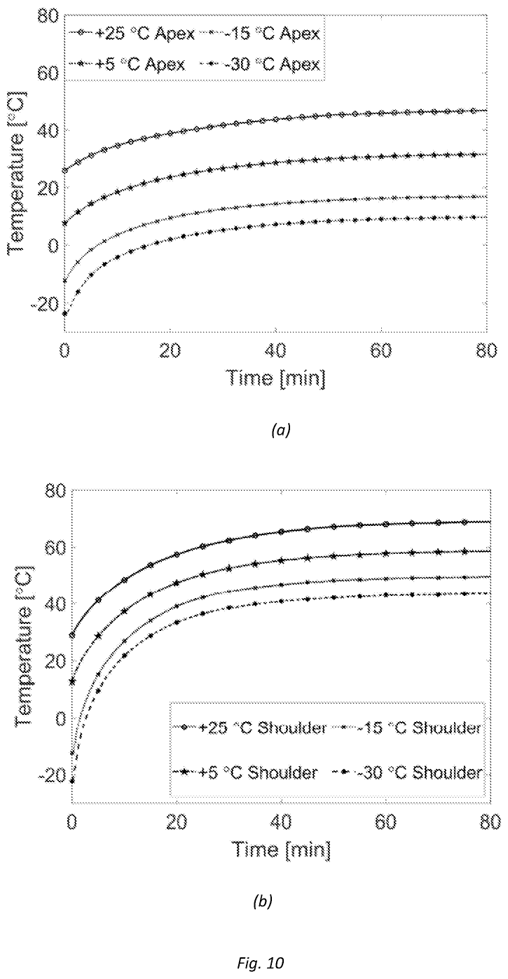

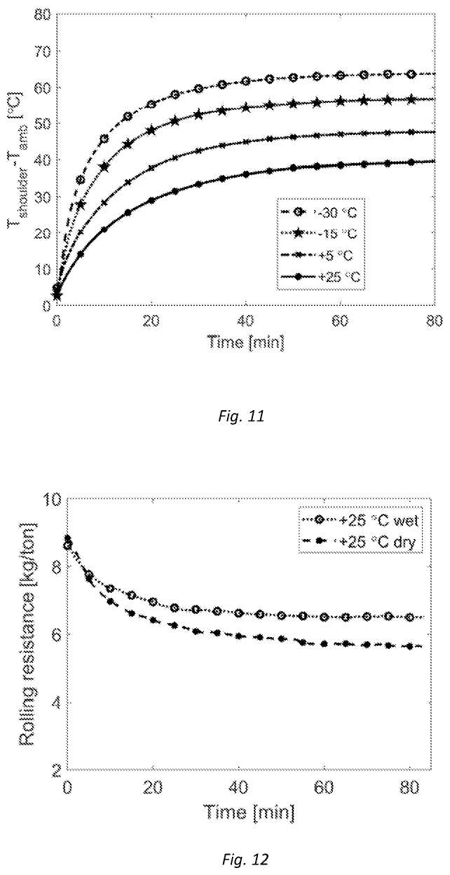

FIG. 10(a) illustrates the temperature warm up at the tire apex and FIG. 10(b) illustrates the temperature warm up at the tire shoulder. It can be clearly seen that the shoulder measurements reach higher temperatures than the apex measurements. Moreover, the apex temperatures reach a substantially steady temperature slower compared to the tire shoulder temperatures. Furthermore, not only does the tire rubber temperature converge to a lower temperature when the ambient temperature decreases, as shown in FIG. 10, but also the differences between the tire shoulder temperature and ambient temperature increase with the decreasing ambient temperatures. This is shown in FIG. 11. This is an indicator that more energy must be put into the tire to heat up a large mass of rubber with a certain type of heat capacity up to a higher temperature difference between the tire and ambient temperature.

According to one alternative, the transient part of the rolling resistance could be presented as an average rolling resistance over a certain drive time at different temperatures, which could be a more meaningful value to compare in range calculations without actually modelling the transient rolling resistance at every instance. To get a more representative value of the rolling resistance for a given drive event, an averaged rolling resistance over a certain drive time, C_{rr_AVG} (t), is proposed according to Equation 2, where t_{drive_time} is the duration of the drive event.

$${C}_{rr \_ AVG} ( t ) = \frac{1}{{t}_{drive , time}} {\int }_{t = 0}^{{t}_{drive , time}} {C}_{r r} ( t ) d t \qquad Eq . 2$$

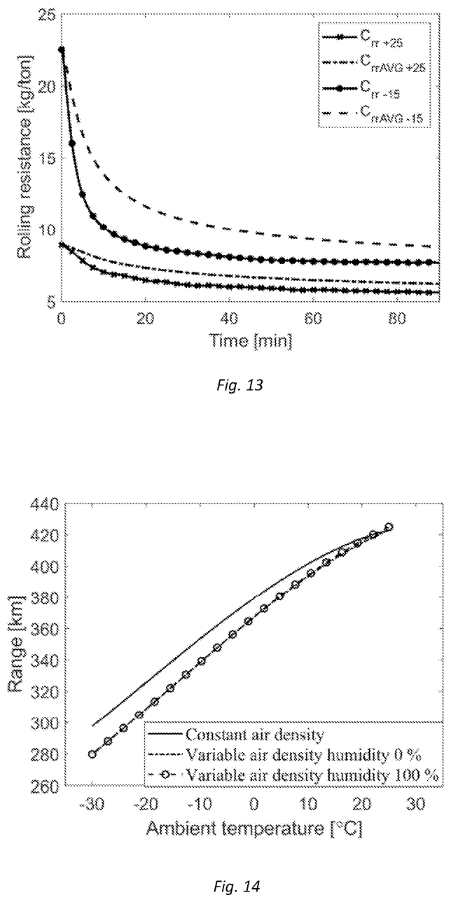

An averaged rolling resistance plot gives an insight into the real-life rolling resistance at different drive times. FIG. 13 shows both the actual and averaged rolling resistance C_{rr_AVG} for a given drive time at different ambient temperatures, more specifically at −15° C. and +25° C., respectively. It can be seen that, as an example, when driving 50 minutes at −15° C., the average rolling resistance would be about 1.75 kg/ton higher than the current Cᵣᵣ(t) value. The proposed average rolling resistance plots can be extracted with commonly used testing methods used according to the ISO 28580:2009 EU labelling (except for the coast-down method).

FIG. 12 illustrates rolling resistance results with dry and wet driving conditions at ambient temperature +25° C. plotted over time. It can be seen that the tests starts from a similar rolling resistance, but the dry measurements converge into approximately 15% lower rolling resistance than the wet measurements. The fact that both rolling resistance measurements start from similar values indicates that there is not enough water spraying to generate a water layer that the tire has to pump away from the contact surface of the tire. Therefore, it can be concluded that most of the increase in rolling resistance in this test is due to lower tire rubber temperature caused by the wet driving conditions.

Furthermore, to illustrate the importance of considering variation of rolling resistance in range estimations, simulations were conducted comparing the range of a hypothetical long haulage battery electric truck (BET) driving at a constant velocity of 80 km/h at different ambient temperatures (T_{amb}). The following values are chosen for the range calculation: the battery size (W_{bat}) is 600 kWh, the state of charge window (d_{SOC}) is 80% (useable battery capacity), battery and the total powertrain efficiency (ηₚₜ) is 0.94, the aerodynamic drag coefficient (C_{d}) is 0.5 and the cross-sectional area of the vehicle front (A) is 10 m². For simplification, it is assumed that the vehicle has the same tires at every axle with the same rolling resistance coefficient. Furthermore, a vehicle weight (m_{truck}) of 40 tons is used in the simulations. The average rolling resistance after driving 155 min (C_{rr_AVG}) (determined according to Equation 2 above) used in the simulations was 5.9 kg/ton at +25° C., 6.6 kg/ton at +5° C., 8.3 kg/ton at −15° C., and 9.3 kg/ton at −30° C. The force opposing the vehicle motion is calculated according to Equation 3.

$${F}_{r} = {C}_{rr \_ AVG} ( {T}_{a m b} ) {m}_{t r u c k} g + \frac{1}{2} {ρ}_{a i r} ( {T}_{a m b} , Φ ) {C}_{d} A {V}^{2} + {m}_{truck} \frac{dV}{dt} + {m}_{t r u c k} g sin α + \frac{{P}_{int}}{V} \qquad Eq . 3$$

where average rolling resistance C_{rr_AVG} is a function of ambient temperature T_{amb}, the density of air Pair is a function of both ambient temperature T_{amb} and relative air humidity Φ, g is the gravitational acceleration and V is the vehicle velocity. For simplicity, it here is assumed that the inclination of the road a and internal and accessory losses Pᵢₙₜ are zero. The vehicle is driving in a long haulage application, which is why acceleration losses can be assumed to be near zero also. Both air density and rolling resistance are varied respective temperatures. Dry air density is calculated according to Equation 4, where p represents pressure and R_{specific} is the mass-specific gas constant.

$$ρ ( {T}_{a m b} ) = \frac{p}{{R}_{specific} {T}_{a m b}} , ( {R}_{specific} = 287.058 \frac{J}{kgK} ) \qquad Eq . 4$$

Calculations and coefficients for the humid air are done using the method shown in Davis, R. S. (1992) ‘Equation for the determination of the density of moist air (1981/91)’, Metrologia, 29, pp. 67-70, doi: 10.1088/0026-1394/29/1/008.

The needed propulsion power Pᵣ for the vehicle is calculated according to Equation 5 and the resulting range S_{range} is calculated according to Equation 6.

$$Pr = \frac{{F}_{r} V}{{η}_{pt}} \qquad Eq . 5$$

$${S}_{r a n g e} = \frac{{d}_{SOC} {W}_{bat} V}{{P}_{r}} \qquad Eq . 6$$

FIG. 14 illustrates the effect of different ambient temperatures on the simulated BET range because of the change in rolling resistance according to the earlier mentioned average rolling resistance values (at t=155 min. The largest change is because of the change in rolling resistance (solid line). The change of air density also plays some role for the range (dashed line), but there seems to be only marginal difference between zero relative humidity and 100% relative humidity (dashed line with circles).

Furthermore, it can be clearly seen that the range drops significantly with decreasing temperature. At a very cold temperature, −30° C., the range has dropped approximately 29% from the range at +25° C. ambient temperature only because of the rolling resistance. When both rolling resistance and aerodynamic resistance is varied, the decrease in range is 34%.

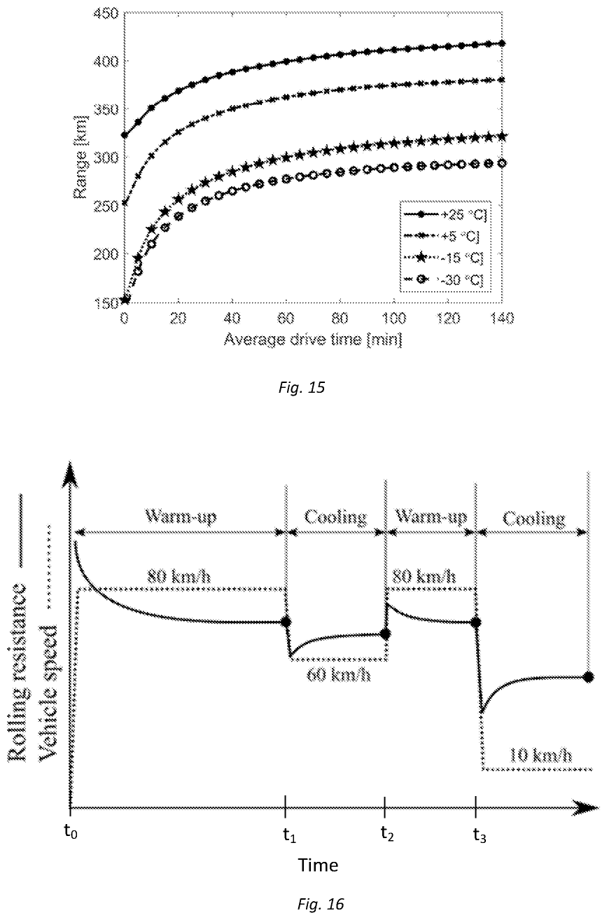

FIG. 15 depicts the range that the vehicle can cover with different lengths of driving trips, where the averaged rolling resistance is varied depending on the drive time =X. As an example, if all the trips are only 20 minutes long (X=20) and the tires always have time to cool down during the stops, the vehicle could cover approximately 325 km distance at +5° C. If the trips would be 160 minutes long at the same temperature the vehicle would have a 380 km range. This is a very important finding, which could be very valuable when planning routes including stops for e.g. commercial vehicles. In regard of a planned upcoming driving event, each X minute trip or drive, here exemplified with X=20, could be what is earlier referred to as a portion of the planned upcoming driving event. The different portions of a driving event could, however, each have a different duration and/or length.

FIG. 16 schematically illustrates the change in rolling resistance over time when the vehicle speed is changed, when there is no change in ambient temperature and with dry road conditions. In the figure, the vehicle starts driving at to and the speed is quickly increased to 80 km/h. The tire rubber temperature at to is here assumed to essentially correspond to the ambient temperature. The vehicle speed is thereafter changed to 60 km/h at t₁ and back to 80 km/h at t₂. At t₃, the vehicle speed is changed to 10 km/h. For the purpose of this illustration, it is here assumed that a thermal balance between dissipation of heat from the rubber and temperature effects from the surrounding environment is reached at or shortly before t₁, t₂, and t₃, respectively. It should however be noted that this may not necessarily occur during realistic driving conditions where said thermal balance may be difficult to reach.

As can be seen from FIG. 16, the rolling resistance decreases during the period from to to t₁. This a result of dissipation of energy during loading/unloading of the rubber causing a warm-up of the tire rubber temperature as described above. Although the tire rubber temperature has increased from to to t₁, the reduction of vehicle speed at t₁ results in a drop of rolling resistance resulting from the change in vehicle speed causing a lower frequency of the loading/unloading of the rubber. Driving at the lower speed of 60 km/h also causes a cooling of the tire rubber temperature, compared to the tire rubber temperature reached at t₁, because of the lower frequency of the loading/unloading of the rubber. In other words, there is no longer a thermal balance when the vehicle speed is changed at t₁. This in turn will result in an increase in rolling resistance during the period of driving at 60 km/h, i.e. between t₁ and t₂, until a thermal balance has been reached again (here assumed to be reached at or shortly before t₂). At t₂, when the vehicle speed is increased to 80 km/h, there is an increase in rolling resistance resulting from the increase vehicle speed leading to an increased frequency of the loading/unloading of the rubber. This increased vehicle speed will also over time result in an increase in the tire rubber temperature due to higher dissipation of energy, and the rolling resistance therefore decreases between t₂ and t₃ until thermal balance has been reached again. The change in vehicle speed at t₃ will result in a drop in rolling resistance resulting from the change of vehicle speed causing a lower frequency of loading/unloading the rubber. The change in vehicle speed will therefore also result in less dissipation of heat which may heat up the tire and therefore a cooling effect on the tire rubber temperature. This means that rolling resistance increases over time after t₃, as shown in the figure.

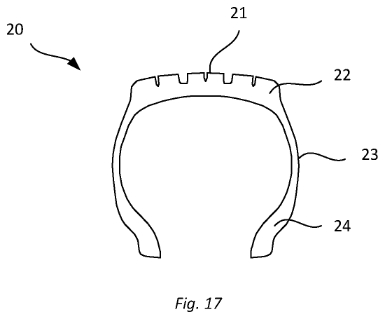

For the purpose of clarifying the various portions of a tire as discussed herein, FIG. 17 schematically illustrates a cross-sectional view of a tire 20. The tire 20 has a crown 21 and a shoulder 22. The shoulder is the area where the thread and sidewall 23 of the tire meet. The crown 21 and the shoulder 22 together form a circumferential portion of the tire and are configured to face towards a road surface. The tire 20 further comprises an apex 24. The apex 24 is not in contact with the road surface but arranged closer to the wheel rim (not shown).

1. A method, performed by a control device, for estimating a distance to empty for a vehicle, the method comprising the following steps:
determining an estimated duration of transient tire rubber temperature behavior of the vehicle for a planned upcoming driving event based on predicted driving conditions of the vehicle for the planned upcoming driving event;
determining an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature; and
estimating the distance to empty based on available driving energy for the vehicle and in consideration of the estimated duration of transient tire rubber temperature behavior and the determined averaged rolling resistance coefficient during the transient tire rubber temperature behavior.

2. The method according to claim 1, wherein the step of determining estimated duration of transient tire rubber temperature behavior comprises:
estimating an initial tire rubber temperature at the start of the planned upcoming driving event; and
based on the estimated initial tire rubber temperature, ambient temperature and the predicted driving conditions for the vehicle, determining an estimated duration until the tire has reached a temperature equal to or above a predetermined temperature threshold.

3. The method according to claim 1, further comprising:
identifying one or more portions of the planned driving event during which a transient tire rubber temperature behavior of the vehicle may occur,
wherein the steps of determining an estimated duration of transient tire rubber temperature behavior of the vehicle for the planned upcoming driving event based on predicted driving conditions of the vehicle for the planned upcoming driving event and determining an average rolling resistance coefficient during the transient tire rubber temperature behavior are performed for each of said one or more identified portions of the planned driving event,
and wherein the step of estimating the distance to empty is performed in consideration of the estimated duration of transient tire rubber temperature and the determined averaged rolling resistance coefficient during the transient tire rubber temperature behavior for each of said one or more identified portions of the planned driving event.

4. The method according to claim 1, wherein the step of determining an estimated duration of transient tire rubber temperature behavior comprises determining the estimated duration of transient tire rubber temperature based on stored reference data.

5. The method according to claim 1, wherein the predicted driving conditions comprises at least vehicle speed and vehicle load.

6. The method according to claim 1, wherein the predetermined transient rolling resistance coefficient model further takes into account an estimated tire rubber temperature at initiation of the transient tire rubber temperature behavior.

7. The method according to claim 1, wherein the predetermined transient rolling resistance coefficient model further takes into account one or more parameters that may cause a cooling or warming effect of the tire during driving.

8. The method according to claim 7, wherein the one or more parameters that may cause a cooling or warming effect of the tire during driving comprises rain, wet road conditions, humidity, and/or braking.

9. A computer program product stored on a non-transitory computer-readable medium, said computer program product for estimating a distance to empty for a vehicle, wherein said computer program product comprising computer instructions to cause one or more computing devices to perform the following operations:
determining an estimated duration of transient tire rubber temperature behavior of the vehicle for a planned upcoming driving event based on predicted driving conditions of the vehicle for the planned upcoming driving event;
determining an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature; and
estimating the distance to empty based on available driving energy for the vehicle and in consideration of the estimated duration of transient tire rubber temperature behavior and the determined averaged rolling resistance coefficient during the transient tire rubber temperature behavior.

10. (canceled)

11. A control device configured to estimate distance to empty for a vehicle, wherein the control device is configured to:
determine an estimated duration of transient tire rubber temperature behavior of the vehicle for a planned upcoming driving event based on predicted driving conditions of the vehicle for the planned upcoming driving event;
determine an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature; and
estimate the distance to empty based on available driving energy for the vehicle and in consideration of the estimated duration of transient tire rubber temperature behavior and the determined averaged rolling resistance coefficient during the transient tire rubber temperature behavior.

12. A vehicle comprising control device configured to estimate distance to empty for a vehicle, wherein the control device is configured to:
determine an estimated duration of transient tire rubber temperature behavior of the vehicle for a planned upcoming driving event based on predicted driving conditions of the vehicle for the planned upcoming driving event;
determine an average rolling resistance coefficient during the transient tire rubber temperature behavior based on the determined estimated duration of transient tire rubber temperature behavior and a predetermined transient rolling resistance coefficient model according to which a transient rolling resistance coefficient is calculated as a function of ambient temperature; and
estimate the distance to empty based on available driving energy for the vehicle and in consideration of the estimated duration of transient tire rubber temperature behavior and the determined averaged rolling resistance coefficient during the transient tire rubber temperature behavior.

13. The computer program product according to claim 9, wherein determining estimated duration of transient tire rubber temperature behavior comprises:
estimating an initial tire rubber temperature at the start of the planned upcoming driving event; and
based on the estimated initial tire rubber temperature, ambient temperature and the predicted driving conditions for the vehicle, determining an estimated duration until the tire has reached a temperature equal to or above a predetermined temperature threshold.

14. The computer program product according to claim 9, wherein said computer program product further comprises computer instructions to cause one or more computing devices to perform the following operations:
identifying one or more portions of the planned driving event during which a transient tire rubber temperature behavior of the vehicle may occur,
wherein determining an estimated duration of transient tire rubber temperature behavior of the vehicle for the planned upcoming driving event based on predicted driving conditions of the vehicle for the planned upcoming driving event and determining an average rolling resistance coefficient during the transient tire rubber temperature behavior are performed for each of said one or more identified portions of the planned driving event,
and wherein estimating the distance to empty is performed in consideration of the estimated duration of transient tire rubber temperature and the determined averaged rolling resistance coefficient during the transient tire rubber temperature behavior for each of said one or more identified portions of the planned driving event.

15. The computer program product according to claim 9, wherein determining an estimated duration of transient tire rubber temperature behavior comprises determining the estimated duration of transient tire rubber temperature based on stored reference data.

16. The computer program product according to claim 9, wherein the predicted driving conditions comprises at least vehicle speed and vehicle load.

17. The control device according to claim 11, wherein determine estimated duration of transient tire rubber temperature behavior comprises:
estimate an initial tire rubber temperature at the start of the planned upcoming driving event; and
based on the estimated initial tire rubber temperature, ambient temperature and the predicted driving conditions for the vehicle, determine an estimated duration until the tire has reached a temperature equal to or above a predetermined temperature threshold.

18. The control device according to claim 11, wherein said control device is further configured to:
identify one or more portions of the planned driving event during which a transient tire rubber temperature behavior of the vehicle may occur,
wherein determine an estimated duration of transient tire rubber temperature behavior of the vehicle for the planned upcoming driving event based on predicted driving conditions of the vehicle for the planned upcoming driving event and determine an average rolling resistance coefficient during the transient tire rubber temperature behavior are performed for each of said one or more identified portions of the planned driving event,
and wherein estimate the distance to empty is performed in consideration of the estimated duration of transient tire rubber temperature and the determined averaged rolling resistance coefficient during the transient tire rubber temperature behavior for each of said one or more identified portions of the planned driving event.

19. The control device according to claim 11, wherein determine an estimated duration of transient tire rubber temperature behavior comprises determine the estimated duration of transient tire rubber temperature based on stored reference data.

20. The control device according to claim 11, wherein the predicted driving conditions comprises at least vehicle speed and vehicle load.

21. The control device according to claim 11, wherein determine estimated duration of transient tire rubber temperature behavior comprises:
estimate an initial tire rubber temperature at the start of the planned upcoming driving event; and
based on the estimated initial tire rubber temperature, ambient temperature and the predicted driving conditions for the vehicle, determine an estimated duration until the tire has reached a temperature equal to or above a predetermined temperature threshold.
